(19) United States
(12) Patent Application Publication
(10) Pub. No.: US 2025/0292107 A1
(43) Pub. Date: Sep. 18, 2025

(54) COMPLETING TEMPORAL KNOWLEDGE GRAPHS BASED ON ENHANCED ENTITY REPRESENTATION AND WEIGHTED FREQUENCY-BASED SAMPLING

(71) Applicant: Adobe Inc., San Jose, CA (US)

(72) Inventors: Ryan A Rossi, Santa Clara, CA (US); Mehrnoosh sadat Mirtaheri feijani, Los Angeles, CA (US); Sungchul Kim, San Jose, CA (US); Kanak Mahadik, San Jose, CA (US); Tong Yu, San Jose, CA (US); Xiang Chen, Palo Alto, CA (US)

(21) Appl. No.: 18/602,753

(22) Filed: Mar. 12, 2024

(51) Int. Cl. G06N 5/02

(52) U.S. Cl. CPC G06N 5/02

(57) ABSTRACT

The present disclosure relates to systems, methods, and non-transitory computer-readable media that generate predicted relationships for entities of a temporal knowledge graph using enhanced entity representations. For instance, in one or more embodiments, the disclosed systems generate a query for predicting a relationship for a subject entity represented within a temporal knowledge graph. The disclosed systems further determine an enhanced entity representation generated for the subject entity by an enhancement layer of a temporal knowledge graph completion model, the enhanced entity representation including a combination of a connection-based similarity for the subject entity and a relationship-based similarity for the subject entity. Using the temporal knowledge graph completion model and based on the enhanced entity representation of the subject entity, the disclosed systems generate a predicted relationship for the subject entity.

### BACKGROUND

Recent years have seen significant advancement in hardware and software platforms for leveraging data represented in various datasets to provide some benefit. For instance, some systems use a dataset to make various predictions for data that is unrepresented within the dataset. Where a dataset is represented by a temporal knowledge graph, these systems can use methods of interpolation or extrapolation to perform a graph completion task in which connections between various nodes of the graph are predicted for a particular time.

Despite these advances, however, conventional temporal knowledge graph completion systems suffer from several technological shortcomings that result in inflexible, inaccurate, and inefficient operation. For instance, many conventional systems are inflexible in that they employ models that fail to accommodate new or otherwise sparse entities represented within a temporal knowledge graph. Indeed, many conventional systems employ models that learn entity representations (e.g., embeddings) during training and use those entity representations to make predictions. These models, however, tend to learn their entity representations based on a restrictive local neighborhood proximity view of entity similarity. Thus, conventional systems often employ models that identify similarities between various entities solely based on their connectivity (e.g., proximity) within the temporal knowledge graph. Further, many conventional systems select entities for use during the training process using a sampling method that favors well-connected entities, leaving sparsely-connected entities-including those that have newly emerged within the temporal knowledge graph-unseen during training. As such, these conventional systems produce and implement models that are ill equipped to generate predictions that account for these oft-unseen entities.

In addition to flexibility concerns, conventional temporal knowledge graph completion systems often operate inaccurately. For instance, by producing and implementing models that fail to accommodate new or otherwise sparse entities, conventional systems tend to fail to perform accurately at the graph completion task, particularly where new entities or relationships are involved. In particular, conventional systems tend to inaccurately predict connections between various entities for a particular time. Additionally, conventional systems typically attempt to accommodate the changes of a temporal knowledge graph over time by fine tuning their model parameters based on those changes. The fine tuning implemented by these systems, however, often leads to overfitting of the model parameters, causing catastrophic forgetting and degraded performance on previously learned tasks.

Further, conventional temporal knowledge graph completion systems also experience problems with efficiency. In particular, some conventional systems aim to avoid the catastrophic forgetting problem by retraining their models entirely upon determining that the temporal knowledge graph has been updated. This approach is computationally demanding, however. Thus, these systems tend to require a significant amount of computing resources (e.g., memory and processing power) to maintain updated model parameters.

These, along with additional problems and issues exist with regard to conventional temporal knowledge graph completion systems.

### SUMMARY

One or more embodiments described herein provide benefits and/or solve one or more problems in the art with systems, methods, and non-transitory computer-readable media that complete temporal knowledge graphs using enhanced entity representations and weighted frequency-based sampling. To illustrate, in one or more embodiments, a system trains a model for graph completion using an incremental training framework that combines a model-agnostic enhancement layer with a weighted sampling strategy. In some embodiments, the system uses the enhancement layer to incorporate a global definition of entity similarity when determining entity representations. Further, the system uses the weighted sampling strategy to accentuate the presence of new or otherwise sparse entities within the training data. In some cases, the system also employs a transition function that updates entity representations using new events to facilitate incremental updates to the model in response to changes in the temporal knowledge graph. In this manner, the system flexibly and efficiently accommodates new or otherwise sparse entities to more accurately perform graph completion at inference time.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which an enhanced graph completion system operates in accordance with one or more embodiments;

FIG. 2 illustrates the enhanced graph completion system generating a predicted relationship in accordance with one or more embodiments;

FIG. 3 illustrates the enhanced graph completion system training a temporal knowledge graph completion model using a continual learning framework in accordance with one or more embodiments;

FIG. 4 illustrates the enhanced graph completion system determining and/or updating parameters of a temporal knowledge graph completion model in accordance with one or more embodiments;

FIG. 5 illustrates a table reflecting experimental results regarding the effectiveness of the enhanced graph completion system in accordance with one or more embodiments;

FIG. 6 illustrates another table reflecting experimental results regarding the effectiveness of the enhanced graph completion system in accordance with one or more embodiments;

FIG. 7 illustrates yet another table reflecting experimental results regarding the effectiveness of the enhanced graph completion system in accordance with one or more embodiments;

FIG. 8 illustrates a graph reflecting further experimental results regarding the effectiveness of the enhanced graph completion system in accordance with one or more embodiments;

FIG. 9 illustrates an example schematic diagram of an enhanced graph completion system in accordance with one or more embodiments;

FIG. 10 illustrates a flowchart of a series of acts for generating a predicted relationship for an entity represented in a temporal knowledge graph in accordance with one or more embodiments; and

FIG. 11 illustrates a block diagram of an exemplary computing device in accordance with one or more embodiments.

### DETAILED DESCRIPTION

One or more embodiments described herein include an enhanced graph completion system that employs a model based on enhanced entity representation and weighted sampling to predict entity representations for temporal knowledge graph completion. For instance, in some embodiments, the enhanced graph completion system trains a model for graph completion using a model-agnostic enhancement layer that incorporates global approach to similarity when determining entity representations. The enhanced graph completion system further trains the model by selecting entities for training via weighted frequency-based sampling, ensuring that new entities or entities that are otherwise sparsely connected are incorporated into the training process. In some implementations, the enhanced graph completion system trains the model using a continual learning (e.g., incremental training) framework that updates model parameters based on the most recent events represented within the graph. Thus, the enhanced graph completion system responds to a query by using an up-to-date version of the model to generate a predicted relationship (e.g., a predicted connection) between entities of the temporal knowledge graph.

To illustrate, in one or more embodiments, the enhanced graph completion model generates a query for predicting a relationship for a subject entity represented within a temporal knowledge graph. Further, the enhanced graph completion model determines an enhanced entity representation generated for the subject entity by an enhancement layer of a temporal knowledge graph completion model, the enhanced entity representation including a combination of a connection-based similarity for the subject entity and a relationship-based similarity for the subject entity. Using the temporal knowledge graph completion model and based on the enhanced entity representation of the subject entity, the enhanced graph completion model generates a predicted relationship for the subject entity.

As just indicated, in one or more embodiments, the enhanced graph completion system trains and implements a temporal knowledge graph completion model that includes an enhancement layer. In some embodiments, the enhancement layer is a model-agnostic enhancement layer. Thus, the temporal knowledge graph completion model also includes a completion component that includes various models in various embodiments.

In one or more embodiments, the enhanced graph completion system uses the enhancement layer to generate enhanced entity representations for entities represented within a temporal knowledge graph. In some cases, the enhanced graph completion system generates the enhanced entity representations using a global definition of entity similarity. For instance, in some embodiments, the enhanced graph completion system generates an enhanced entity representation for a given entity using a combination of a connection-based similarity for the entity and a relationship-based similarity for the entity. In some implementations, the enhanced graph completion system assigns a higher weight to the relationship-based similarity where the entity has fewer connections within the temporal knowledge graph.

Thus, in one or more embodiments, the enhanced graph completion system trains the temporal knowledge graph completion model using the enhanced entity representations generated for the entities with a temporal knowledge graph. Further, in some embodiments, the enhanced graph completion system utilizes the temporal knowledge graph completion model to generate predicted relationships at inference time based on the enhanced entity representations.

As further mentioned, in one or more embodiments, the enhanced graph completion system trains the temporal knowledge graph completion model using weighted frequency-based sampling. Indeed, in some embodiments, the enhanced graph completion system employs a sampling strategy that increases the probability of selecting an entity for use in training where the entity appears withing the temporal knowledge graph with low frequency (e.g., has few connections within the graph). Thus, the enhanced graph completion system boosts the visibility of sparsely connected entities during training.

Additionally, as indicated, in one or more embodiments, the enhanced graph completion system trains the temporal knowledge graph completion model using a continual learning framework. For instance, in some instances, the enhanced graph completion system updates the model parameters as the temporal knowledge graph is updated. In certain embodiments, the enhanced graph completion system updates the enhanced entity representations used to update the model parameters by focusing on the most recent events represented within the temporal knowledge graph and their corresponding entities.

Further, as indicated, the enhanced graph completion system uses the temporal knowledge graph completion model to perform graph completion in response to a query in some instances. In particular, the enhanced graph completion system generates a predicted relationship in response to the query. In some cases, the enhanced graph completion system generates the predicted relationship by predicting the object entity that will have a relationship with a subject entity at a given time. In some instances, the enhanced graph completion system predicts the relationship that will be associated with a subject entity and an object entity at a given time.

The enhanced graph completion system provides several advantages over conventional systems. For instance, the enhanced graph completion system operates with improved flexibility when compared to conventional systems. In particular, by generating enhanced entity representations based on both connection-based similarities and relationship-based similarities, the enhanced graph completion system untethers the entity representations from the restrictive local neighborhood proximity view of entity similarity. As such, the enhanced graph completion model flexibly trains and implements its model to identify similarities between entities even where those entities are not connected within the temporal knowledge graph. Further, by using weighted frequency-based sampling to select entities for use in the training process, the enhanced graph completion system flexibly boosts the visibility of sparse entities during training. Indeed, the enhanced graph connection system learns and uses model parameters that account for entities that are typically ignored by the models of conventional systems for graph completion.

Additionally, the enhanced graph completion system operates with improved accuracy when compared to conventional systems. In particular, by training and implementing a temporal knowledge graph completion model to account for new or otherwise sparsely connected entities, the enhanced graph completion system more accurately predicts relationships between entities of a temporal knowledge graph. Further, by using enhanced entity representations and weighted frequency-based sampling, the enhanced graph completion system mitigates the catastrophic forgetting that often plagues conventional systems.

Further, the enhanced graph completion system operates with improved efficiency when compared to conventional systems. Indeed, by mitigating the effects of catastrophic forgetting when updating the model, the enhanced graph completion system facilitates updating the model parameters via incremental training. Thus, the enhanced graph completion system maintains updated model parameters without retraining the model entirely, reducing the computing resources that are sometimes required to keep the model current.

As illustrated by the foregoing discussion, the present disclosure utilizes a variety of terms to describe features and benefits of the enhanced graph completion system. Additional detail is now provided regarding the meaning of these terms. For example, as used herein, the term “temporal knowledge graph” refers to a knowledge graph that includes temporal information. In particular, in some embodiments, a temporal knowledge graph includes a structured representation of knowledge that includes nodes, connections (e.g., edges) between the nodes, and timestamps associated with the nodes and/or the edges. In some cases, a temporal knowledge graph evolves over time. For instance, in some implementations, a temporal knowledge graph changes to include additional nodes and/or connections between the nodes represented therein. Thus, in some implementations, a temporal knowledge graph goes through several iterations where each iteration represents the temporal knowledge graph (e.g., the included nodes and edges) at a particular time.

Additionally, as used herein, the term “entity” refers to a distinct object or concept. For example, in some embodiments, an entity includes, but is not limited to, a person, an organization, a document or file or other item of content (digital or physical), a country or state or city, an idea, an action, or a category. In one or more embodiments, an entity is represented as a node within a temporal knowledge graph. Thus, in some cases, an entity includes an object, concept, or other thing that is representable as a distinct node within a temporal knowledge graph separately from other objects, concepts, or things that are represented as other nodes. In some implementations, a temporal knowledge graph includes nodes representing a variety of entity types (e.g., a film-based temporal knowledge graph having nodes that represent production companies, movies, directors, score composers, actors, and actresses).

Further, as used herein, the term “relationship” refers to an association between entities. In particular, in some embodiments, a relationship refers to a relationship or association between at least two entities due to an event involving the at least two entities. To illustrate, in some cases, a relationship includes an act performed by one entity with respect to at least one other entity (e.g., a document referencing another document, a production company releasing a movie, or a country attacking another country). In some instances, a relationship includes an act mutually performed by at least two entities (e.g., two people having a meeting). In one or more embodiments, a relationship is associated with the time (e.g., the year, month, day, time of day, or time period) at which the event occurred or began. In one or more embodiments, a relationship is associated with a particular type. Thus, as used herein, the term “relationship type” refers to a type of association between entities. In other words, in some embodiments, a relationship type more specifically refers to a particular relation type or class between entities. To illustrate, in some cases, a relationship type refers to a relationship class (e.g., a meeting class, a reference class, a movie release class, an attack class) where a particular relationship between two entities includes an instance of a corresponding relationship class. In some embodiments, the enhanced graph completion system establishes or uses a predefined set of relationship types. For instance, in some cases, the enhanced graph completion system processes temporal knowledge graphs that represent relationships that are of relationship types from a set of relationship types. Further, in some instances, the temporal knowledge graph completion system generates a predicted relationship by predicting a relationship of a relationship type that is included in an established set of relationship types.

As used herein, the term “connection” refers to a link or edge within a temporal knowledge graph that represents a relationship between entities. In particular, in some embodiments, a connection refers to an edge (e.g., a directed or undirected edge) between nodes of a temporal knowledge graph that represents a relationship between the entities represented by the nodes. In some implementations, a connection is associated with an event that establishes or triggers a relationship between the corresponding entities. Additionally, in some cases, a connection is associated with a timestamp representing the time at which the corresponding event occurred or began. In some instances, a connection is associated with a particular type (referred to as a “connection type” or “edge type”) that corresponds to the type of relationship represented by the connection.

In one or more embodiments, a relationship includes a subject entity and an object entity. In embodiments, the term “subject entity” refers to the entity perform the action with respect to another entity (e.g., a director directing a movie) while “object entity” refers to the entity being acted upon (e.g., the movie being directed). In some implementations, however, a subject entity more generally includes a first entity that is part of the relationship, and an object entity more generally includes a second entity that is part of the relationship. In other wise, in some cases, the “subject” and “object” designations do not indicate a role in the relationship but are used more generally to distinguish between entities within the relationship.

As used herein, the term “predicted relationship” refers to a prediction of a relationship between entities represented within a temporal knowledge graph. In particular, in some embodiments, a predicted relationship refers to a prediction of a relationship that is not represented within the temporal knowledge graph. For example, in some cases, a predicted relationship refers to a predicted relationship between entities at a timestamp that follows a latest timestamp represented within the temporal knowledge graph. In other words, a predicted relationship refers to a prediction of a future relationship between entities. In some implementations, a predicted relationship more specifically includes a predicted relationship type. Indeed, in some cases, the enhanced graph completion system generates a predicted relationship by predicting the type of relationship between entities at a particular timestamp. In certain embodiments, a predicted relationship refers to a prediction of the relationship itself-a prediction of which relationship will exist between two given entities at a particular time. In some instances, however, a predicted relationship refers to a prediction of an entity (e.g., an object entity) that will be involved in a given relationship with another entity (e.g., a subject entity) at a particular time.

Additionally, as used herein, the term “temporal knowledge graph completion model” refers to a computer-implemented model that performs a graph completion task with respect to a temporal knowledge graph. In particular, in some embodiments, a temporal knowledge graph completion model refers to a computer-implemented model that generates predicted relationships for entities represented within a temporal knowledge graph. For instance, in some cases, a temporal knowledge graph completion model receives a query for predicting a relationship and generates a predicted relationship in response to the query. In some implementations, by predicting a relationship, the temporal knowledge graph completion model predicts or generates a connection (e.g., an edge) between the entities within the temporal knowledge graph. In some cases, a temporal knowledge graph completion model includes a machine learning model, such as a neural network, that has been trained to generate predicted relationships. In some implementations, a temporal knowledge graph completion model further includes an enhancement layer.

As used herein, the term “neural network” refers to a type of machine learning model, which is tunable (e.g., trainable) based on inputs to approximate unknown functions used for generating the corresponding outputs. In particular, in some embodiments, a neural network refers to a model of interconnected artificial neurons (e.g., organized in layers) that communicate and learn to approximate complex functions and generate outputs based on a plurality of inputs provided to the model. In some instances, a neural network includes one or more machine learning algorithms. Further, in some cases, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a generative adversarial neural network, a graph neural network, a multi-layer perceptron, or a diffusion neural network. In some embodiments, a neural network includes a combination of neural networks or neural network components.

Additionally, as used herein, the term “enhancement layer” refers to a model component that generates enhanced entity representations for entities represented within a temporal knowledge graph. In particular, in some embodiments, an enhancement layer refers to a model component that generates an enhanced entity representation for an entity of a temporal knowledge graph based on similarities between that entity and other entities represented in the temporal knowledge graph. In one or more embodiments, as will be described more below, the enhanced graph completion system uses a temporal knowledge graph completion model to generated predicted relationships based on the enhanced entity representations generated by the enhancement layer. In certain embodiments, an enhancement layer is model agnostic and is implementable as part of various types of temporal knowledge graph completion models.

As used herein, the term “enhanced entity representation” refers to a value or set of values representing one or more attributes or characteristics of an entity of a temporal knowledge graph. In particular, in some embodiments, an enhanced entity representation refers to an embedding that includes a value or set of values representing patent and/or latent attributes or characteristics of an entity. To illustrate, in some cases, an enhanced entity representation includes a value or set of values representing one or more similarities between the entity and one or more other entities of the temporal knowledge graph. Indeed, in some instances, an enhanced entity representation includes a combination (e.g., a weighted combination) of similarities between the entity and one or more other entities.

In some cases, an enhanced entity representation for an entity represents one or more connection-based similarities for the entity. As used herein, the term “connection-based similarity” refers to a similarity between an entity and one or more other entities based on their connectivity within a temporal knowledge graph. In particular, in some embodiments a connection-based similarity refers to a similarity between an entity and one or more other entities due their proximity within the temporal knowledge graph (e.g., a local neighborhood proximity).

Further, in some instances, an enhanced entity representation for an entity represents one or more relationship-based similarities for the entity. As used herein, the term “relationship-based similarity” refers to a similarity between an entity and one or more other entities based on their relationships represented within a temporal knowledge graph. In particular, in some embodiments, a relationship-based similarity refers to a similarity between an entity and one or more other entities due to the entities having the same relationship type represented within the temporal knowledge graph (e.g., the same type of connection between nodes corresponding to the entities within the temporal knowledge graph).

As used herein, the term “weighted frequency-based sampling” refers to a sampling strategy that boosts the visibility of low-frequency entities during the training process for a temporal knowledge graph completion model. In particular, in some embodiments, weighted frequency-based sampling refers to a strategy for sampling entities for use in training with a probability that is proportional to the inverse frequency of that entity, where the frequency of an entity corresponds to the number of relationships that involve the entity within a temporal knowledge graph. In some implementations, the weighted frequency-based sampling includes a strategy for sampling events (e.g., quadruples representing existing links in a temporal knowledge graph) based on the inverse frequency of their involved entities. Indeed, in some cases, the enhanced graph completion system samples an entity by sampling an event (e.g., a quadruple) that includes that entity. Further, as will be explained below, the enhanced graph completion system uses weighted frequency-based sampling to increase the likelihood that a low frequency entity will be selected for training a temporal knowledge graph completion model in some cases.

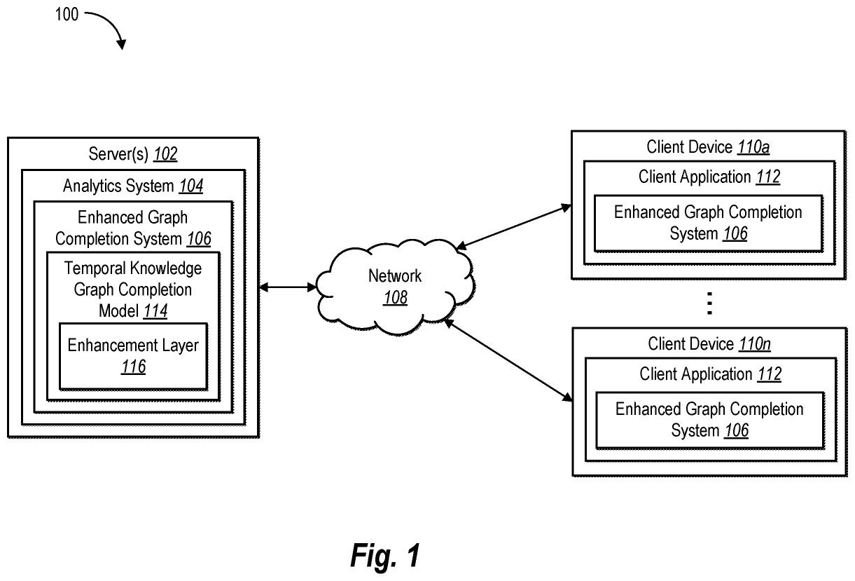

Additional detail regarding the enhanced graph completion system will now be provided with reference to the figures. For example, FIG. 1 illustrates a schematic diagram of an exemplary system 100 in which an enhanced graph completion system 106 operates. As illustrated in FIG. 1, the system 100 includes a server(s) 102, a network 108, and client devices 110a-110n.

Although the system 100 of FIG. 1 is depicted as having a particular number of components, the system 100 is capable of having any number of additional or alternative components (e.g., any number of servers, client devices, or other components in communication with the enhanced graph completion system 106 via the network 108). Similarly, although FIG. 1 illustrates a particular arrangement of the server(s) 102, the network 108, and the client devices 110a-110n, various additional arrangements are possible.

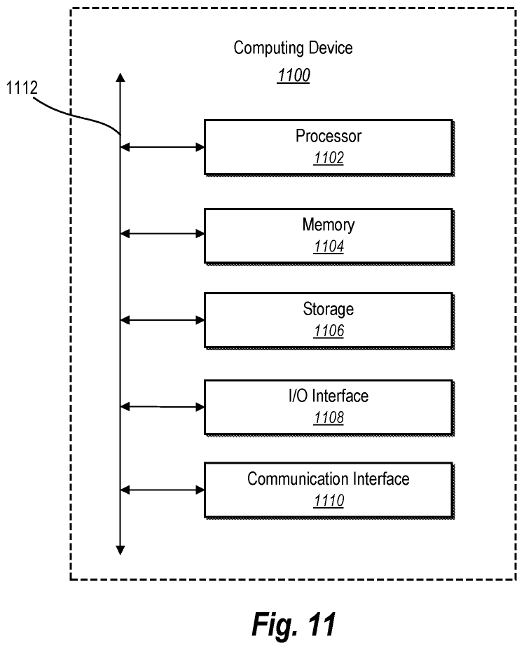

The server(s) 102, the network 108, and the client devices 110a-110n are communicatively coupled with each other either directly or indirectly (e.g., through the network 108 discussed in greater detail below in relation to FIG. 11). Moreover, the server(s) 102 and the client devices 110a-110n include one or more of a variety of computing devices (including one or more computing devices as discussed in greater detail with relation to FIG. 11).

As mentioned above, the system 100 includes the server(s) 102. In one or more embodiments, the server(s) 102 generates, stores, receives, and/or transmits data, including temporal knowledge graphs and/or predicted relationships for entities within temporal knowledge graphs. In one or more embodiments, the server(s) 102 comprises a data server. In some implementations, the server(s) 102 comprises a communication server or a web-hosting server.

In one or more embodiments, the analytics system 104 maintains and leverages data. For example, in some instances, the analytics system 104 maintains, updates, and leverages various datasets in the form of temporal knowledge graphs. To illustrate, in some embodiments, the analytics system 104 analyzes a temporal knowledge graph and generates recommendations or performs natural language processing tasks based on the analysis.

In one or more embodiments, the client devices 110a-110n include computing devices that are capable of accessing, modifying, and/or storing temporal knowledge graphs and/or generate predicted relationships for entities of temporal knowledge graphs. For example, the client devices 110a-110n include one or more of smartphones, tablets, desktop computers, laptop computers, head-mounted-display devices, and/or other electronic devices. In some instances, the client devices 110a-110n include one or more applications (e.g., the client application 112) that capable of accessing, modifying, and/or storing temporal knowledge graphs and/or generate predicted relationships for entities of temporal knowledge graphs. For example, in one or more embodiments, the client application 112 includes a software application installed on the client devices 110a-110n. Additionally, or alternatively, the client application 112 includes a web browser or other application that accesses a software application hosted on the server(s) 102 (and supported by the analytics system 104).

To provide an example implementation, in some embodiments, the enhanced graph completion system 106 on the server(s) 102 supports the enhanced graph completion system 106 on the client device 110n. For instance, in some cases, the enhanced graph completion system 106 on the server(s) 102 generates or learns parameters for the temporal knowledge graph completion model 114 having the enhancement layer 116. The enhanced graph completion system 106 then, via the server(s) 102, provides the temporal knowledge graph completion model 114 with the enhancement layer 116 to the client device 110n. In other words, the client device 110n obtains (e.g., downloads) the temporal knowledge graph completion model 114 (e.g., with any learned parameters) from the server(s) 102. Once downloaded, the enhanced graph completion system 106 on the client device 110n utilizes the temporal knowledge graph completion model 114 with the enhancement layer 116 to generate predicted relationships for entities represented in a temporal knowledge graph independent from the server(s) 102.

In alternative implementations, the enhanced graph completion system 106 includes a web hosting application that allows the client device 110n to interact with content and services hosted on the server(s) 102. To illustrate, in one or more implementations, the client device 110n accesses a software application supported by the server(s) 102. The client device 110n provides input to the server(s) 102, such as a query for predicting a relationship for an entity within a temporal knowledge graph. In response, the enhanced graph completion system 106 on the server(s) 102 generates a predicted relationship for the entity. The server(s) 102 then provides the predicted relationship to the client device 110n for display.

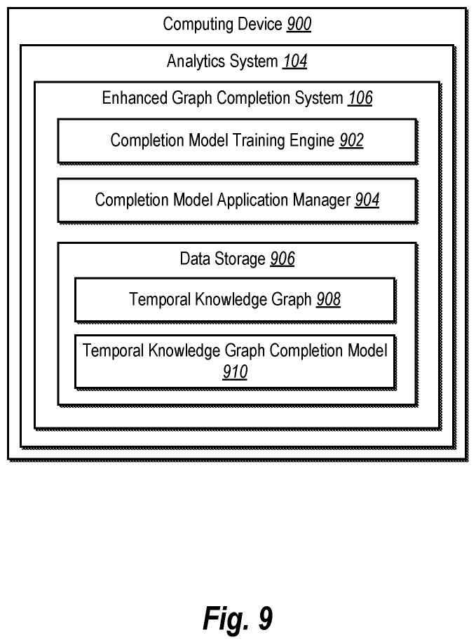

Indeed, the enhanced graph completion system 106 is able to be implemented in whole, or in part, by the individual elements of the system 100. Indeed, although FIG. 1 illustrates the enhanced graph completion system 106 implemented with regard to the server(s) 102, different components of the enhanced graph completion system 106 are able to be implemented by a variety of devices within the system 100. For example, one or more (or all) components of the enhanced graph completion system 106 are implemented by a different computing device (e.g., one of the client devices 110a-110n) or a separate server from the server(s) 102 hosting the analytics system 104. Indeed, as shown in FIG. 1, the client devices 110a-110n include the enhanced graph completion system 106. Example components of the enhanced graph completion system 106 will be described below with regard to FIG. 9.

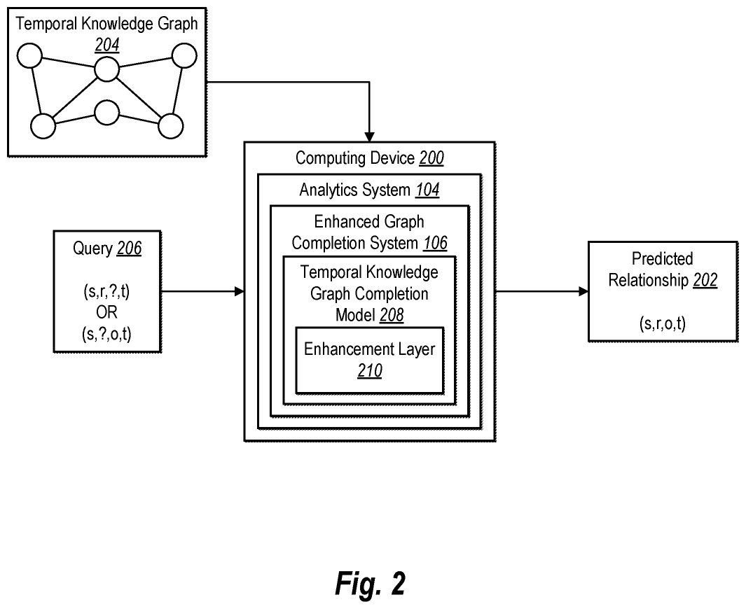

As mentioned, in one or more embodiments, the enhanced graph completion system 106 generates predicted relationships for entities represented within a temporal knowledge graph. FIG. 2 illustrates the enhanced graph completion system 106 generating a predicted relationship in accordance with one or more embodiments.

As shown in FIG. 2, the enhanced graph completion system 106 (operating on a computing device 200) generates a predicted relationship 202 based on a temporal knowledge graph 204. In one or more embodiments, the enhanced graph completion system 106 represents the temporal knowledge graph 204 as G= [symbol] [symbol] , ε, [symbol] [symbol] in which G encapsulates a series of events as a set of quadruples [symbol] ={(s, r, o, τ)|s, o∈ε, r∈ [symbol] }. In this representation, ε represents the set of entities within the temporal knowledge graph 204, [symbol] represents the set of relationships between the entities (or, more specifically, the types of associations or connections between those entities), and t denotes the timestamp of the event's occurrence.

As used herein, the term “event” refers to an occurrence that involves at least two entities at a particular point in time. In some embodiments, an event refers to an interaction between at least two entities. For instance, in some cases, an event includes a one-time interaction at a particular point in time (or an event that is otherwise describable with reference to a particular period of time). As such, in some cases, an event is associated with at least two entities and establishes a relationship between the entities at the time of the event.

In one or more embodiments, the enhanced graph completion system 106 generates the predicted relationship 202 as part of a knowledge graph completion task or, more specifically, a temporal knowledge graph completion task. Indeed, in some embodiments, the enhanced graph completion system 106 predicts potential interactions between entities at a specific point in time by generating predicted relationships. In certain embodiments, the enhanced graph completion system 106 performs the temporal knowledge graph completion task via interpolation by predicting a relationship for a timestamp before the latest timestamp of the temporal knowledge graph 204. In some cases, however, the enhanced graph completion system 106 performs the temporal knowledge graph completion task via extrapolation by predicting a relationship for a timestamp that follows the latest timestamp of the temporal knowledge graph 204.

As further shown in FIG. 2, the enhanced graph completion system 106 generates the predicted relationship 202 in response to a query 206. Indeed, in some cases, the enhanced graph completion system 106 receives the query 206 (e.g., from a client device) and generates the predicted relationship 202 in response (and provides the predicted relationship 202 back to the client device in return). In some implementations, the enhanced graph completion system 106 generates the query 206 (e.g., based on user input received via the computing device 200) and generates the predicted relationship 202 in response.

As FIG. 2 illustrates, the query 206 requests a prediction of a relationship between entities of the temporal knowledge graph 204. In particular, the query 206 requests a prediction of a relationship between a subject entity and an object entity at a particular timestamp. As illustrated, the query 206 takes on various forms in various embodiments. For instance, as illustrated, the query 206 indicates the subject entity, the relationship, and the timestamp in some embodiments. In response to such a query, the enhanced graph completion system 106 generates the predicted relationship 202 by predicting the object entity that will have the indicated relationship with the subject entity at the point in time designated by the timestamp. As further illustrated, the query 206 indicates the subject entity, the object entity, and the timestamp in some cases. In response to such a query, the enhanced graph completion system 106 generates the predicted relationship 202 by predicting the relationship that will exist between the subject entity and the object entity at the point in time designated by the timestamp. Though not shown in FIG. 2, in further embodiments, the query 206 indicates the subject entity, the object entity, and the relationship, and the enhanced graph completion system 106 predicts the next timestamp at which the relationship will exist between the subject entity and object entity in response.

As illustrated, the enhanced graph completion system 106 uses a temporal knowledge graph completion model 208 having an enhancement layer 210 to generate the predicted relationship 202 in response to the query 206. As will be explained in more detail below, in one or more embodiments, the enhanced graph completion system 106 trains the temporal knowledge graph completion model 208 to generate predicted relationships using the temporal knowledge graph 204. To illustrate, in some cases, the enhanced graph completion system 106 uses the enhancement layer 210 to generate enhanced entity representations for the entities of the temporal knowledge graph 204 and uses the enhanced entity representations in learning the model parameters. Thus, the enhanced graph completion system 106 uses the temporal knowledge graph completion model 208 with the learned parameters to respond to the query 206 by generating the predicted relationship 202.

In certain implementations, the enhanced graph completion system 106 also uses the enhancement layer 210 of the temporal knowledge graph completion model 208 at inference time. For instance, in some embodiments, the enhanced graph completion system 106 uses the enhancement layer 210 to generate an enhanced entity representation for the subject entity and/or the object entity indicated by the query 206. The enhanced graph completion system 106 further uses the temporal knowledge graph completion model 208 to generate the predicted relationship 202 based on the generated enhanced entity representation(s).

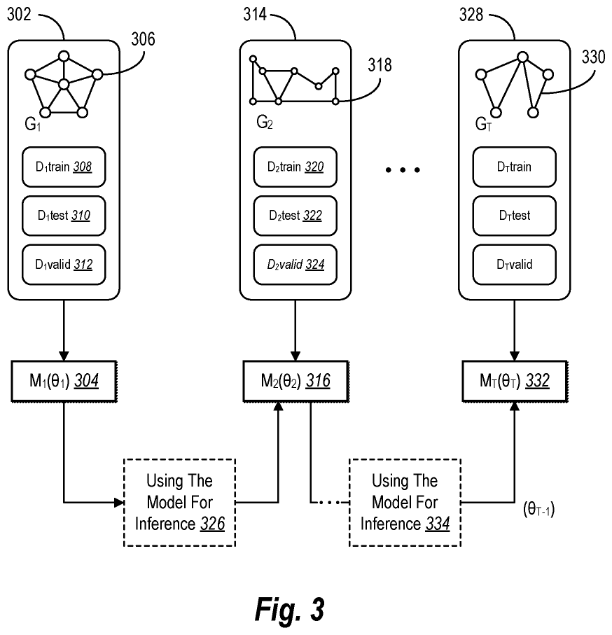

As previously mentioned, in one or more embodiments, the enhanced graph completion system 106 trains a temporal knowledge graph completion model to predict relationships between entities represented in a temporal knowledge graph. In some embodiments, the enhanced graph completion system 106 trains the temporal knowledge graph completion model using a continual learning framework by incrementally updating the model parameters as the graph changes over time. FIG. 3 illustrates the enhanced graph completion system 106 training a temporal knowledge graph completion model using a continual learning framework in accordance with one or more embodiments.

Indeed, in one or more embodiments, the enhanced graph completion system 106 represents a temporal knowledge graph G as a stream of iterations [symbol] G₁, G₂, . . . , G_{T} [symbol] arriving over time. In some cases, each iteration Gₜ= [symbol] [symbol] ₜ, εₜ, [symbol] ₜ [symbol] includes [symbol] ₜ={(s, r, o, τ)|s, o∈εₜ, r∈ [symbol] ₜ, τ∈[τₜ,τₜ₊₁)}, which is the set of quadruples (e.g., events) that occurred within the time interval [τₜ,τₜ₊₁), and εₜ and [symbol] ₜ are the set of entities and relationships, respectively, at time t. In other words, in some cases, the temporal knowledge graph evolves over time so that an iteration of the temporal knowledge graph includes one or more new entities and/or relationships that were not represented within previous iterations.

In some implementations, the enhanced graph completion system 106 implements the continual learning framework by incrementally training the temporal knowledge graph completion model [symbol] via updates to the model parameters θ as new iterations of the temporal knowledge graph become available over time. In some cases, the enhanced graph completion system 106 defines a set of tasks [symbol] [symbol] , . . . , [symbol] [symbol] where each task [symbol] =(Dₜ^{train}, Dₜ^{test}, Dₜ^{val}) consists of disjoint subsets of the Gₜ events. Thus, in some embodiments, the enhanced graph completion system 106 represents the temporal knowledge graph completion model [symbol] as a stream of models [symbol] = [symbol] [symbol] ₁, . . . , [symbol] _{T} [symbol] with corresponding model parameter sets θ= [symbol] θ₁, θ₂ . . . , θ_{T} [symbol] , trained incrementally via a set of tasks [symbol] = [symbol] [symbol] , [symbol] , . . . , [symbol] [symbol] .

Indeed, as shown in FIG. 3, the enhanced graph completion system 106 trains a temporal knowledge graph completion model via a first task 302 to produce a first iteration 304 of the temporal knowledge graph completion model [symbol] ₁ having a first set of parameters θ₁. In particular, the enhanced graph completion system 106 executes the first task 302 using a first iteration 306 of a temporal knowledge graph G₁ that represents a set of entities and a set of relationships. As further shown, the enhanced graph completion system 106 executes the first task 302 by executing a training process 308, a testing process 310, and a validation process 312. In one or more embodiments, the training process 308, the testing process 310, and the validation process 312 each include a plurality of iterative steps. Thus, in some implementations, the enhanced graph completion system 106 executes the first task 302 using a plurality of training steps, a plurality of testing steps, and a plurality of validation steps.

Additionally, as shown in FIG. 3, the enhanced graph completion system 106 updates the temporal knowledge graph completion model via a second task 314 to produce a second iteration 316 of the temporal knowledge graph completion model [symbol] ₂ having a second set of parameters θ₂. In some embodiments, the enhanced graph completion system 106 determines the second set of parameters for the second iteration 316 by updating the first set of parameters of the first iteration 304 of the temporal knowledge graph completion model.

As further shown, the enhanced graph completion system 106 executes the second task 314 using a second iteration 318 of the temporal knowledge graph G₂. In one or more embodiments, the second iteration 318 of the temporal knowledge graph follows the first iteration 306 in time. To illustrate, in some embodiments, the second iteration 318 of the temporal knowledge graph includes the entities and relationships from the first iteration 306. In some cases, the second iteration 318 of the temporal knowledge graph further includes one or more additional entities and/or one or more additional relationships that were not represented in the first iteration 306. In some cases, the additional entities and/or relationships are new entities and/or new relationships associated with new events that occurred after the latest timestamp represented within the first iteration 306 of the temporal knowledge graph.

As shown, the enhanced graph completion system 106 executes the second task 314 by executing a training process 320, a testing process 322, and a validation process 324. In one or more embodiments, the training process 320, the testing process 322, and the validation process 324 each include a plurality of iterative steps. Thus, in some implementations, the enhanced graph completion system 106 executes the second task 314 using a plurality of training steps, a plurality of testing steps, and a plurality of validation steps.

As previously mentioned, in some cases, the enhanced graph completion system 106 uses enhanced entity representations generated by an enhancement layer of the temporal knowledge graph completion model to learn the model parameters. In some cases, when updating the model parameters, the enhanced graph completion system 106 uses the enhancement layer to focus on the most recent events when generating the enhanced entity representations. For instance, in some instances, the enhanced graph completion system 106 uses the enhancement layer to provide a higher weight to newer relationships and their corresponding entities when generating the enhanced entity representations.

As FIG. 3 illustrates, in some embodiments, the enhanced graph completion system 106 performs an act 326 of using the first iteration 304 of the temporal knowledge graph completion model before executing the second task (e.g., before updating the model parameters). In particular, the enhanced graph completion system 106 uses the first iteration 304 with the first set of parameters to generate predicted relationships in response to queries. Indeed, in one or more embodiments, the enhanced graph completion system 106 uses the first iteration 304 of the temporal knowledge graph completion model until the second iteration 318 of the temporal knowledge graph becomes available and the second task 314 is complete. In other words, in some cases, the enhanced graph completion system 106 uses the first iteration 304 of the temporal knowledge graph completion model until the second iteration 316 of the model is ready for use (e.g., the first set of parameters have been updated—or, in other words, the second set of parameters have been determined).

Similarly, as shown in FIG. 3, the enhanced graph completion system 106 updates the temporal knowledge graph completion model by executing a Tth task 328 using a Tth iteration 330 of the temporal knowledge graph. As such, the enhanced graph completion system 106 produces a Tth iteration 332 of the temporal knowledge graph completion model [symbol] _{T} having a Tth set of parameters θ_{T}. In one or more embodiments, the enhanced graph completion system 106 determines the Tth set of parameters by updating the parameters from the preceding iteration of the temporal knowledge graph completion model. As further shown in FIG. 3, in some instances, the enhanced graph completion system 106 performs an act 334 of using the iteration of the temporal knowledge graph completion model that is current at the time to generated predicted relationships in response to queries.

Thus, in one or more embodiments, the enhanced graph completion system 106 uses a continual learning framework to incrementally train a temporal knowledge graph completion model. In particular, the enhanced graph completion system 106 incrementally updates the parameters of the temporal knowledge graph completion model as the temporal knowledge graph changes and new data becomes available. Further, in some embodiments, the enhanced graph completion system 106 deploys the temporal knowledge graph completion model to respond to queries between model updates. Thus, in some implementations, the enhanced graph completion system 106 uses the temporal knowledge graph completion model to generate predicted relationships based on the most current data available.

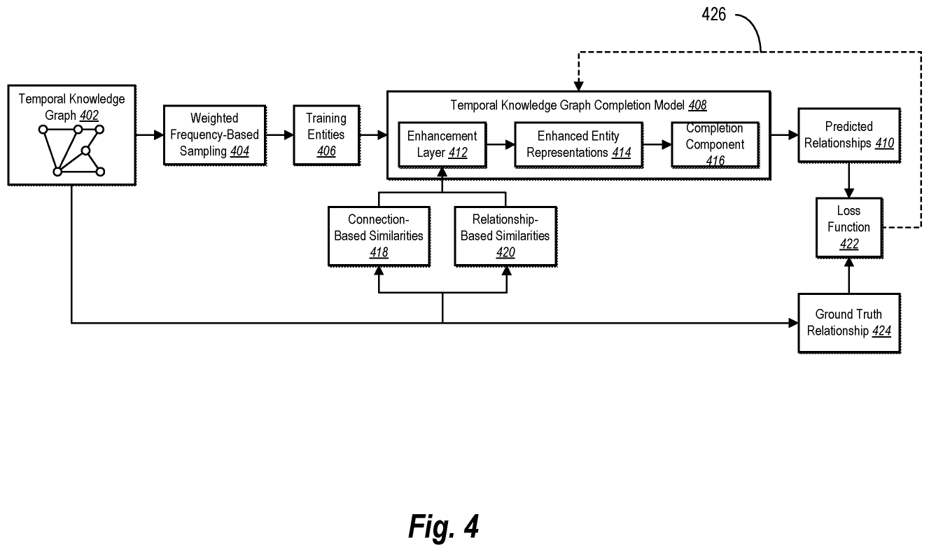

As discussed above, the enhanced graph completion system 106 uses multiple iterative training steps to determine and/or update the parameters of a temporal knowledge graph completion model. In particular, in some embodiments, the enhanced graph completion system 106 uses multiple iterative training steps in each of multiple training stages that are part of the tasks described above. FIG. 4 illustrates the enhanced graph completion system 106 determining and/or updating parameters of a temporal knowledge graph completion model in accordance with one or more embodiments.

As shown in FIG. 4, the enhanced graph completion system 106 uses a temporal knowledge graph 402. In particular, the enhanced graph completion system 106 uses the temporal knowledge graph 402 to extract training data. For instance, as illustrated, the enhanced graph completion system 106 uses a weighted frequency-based sampling 404 to selecting entities from the temporal knowledge graph 402 for use as training entities 406. In one or more embodiments, the enhanced graph completion system 106 selects an entity from the temporal knowledge graph 402 for use as a training entity by sampling a quadruple represented within the temporal knowledge graph 402. In some cases, the enhanced graph completion system 106 uses portions of the quadruple as part of the query and other portions as part of the ground truth. In some implementations, the enhanced graph completion system 106 uses another training set (e.g., a collection of temporal knowledge graphs or other annotated data) to select data for training.

In one or more embodiments, the enhanced graph completion system 106 implements the weighted frequency-based sampling 404 by sampling quadruples from the temporal knowledge graph 402 (or other training set) based on the inverse frequency of either the subject entity or the object entity represented in a quadruple. In other words, the enhanced graph completion system 106 selects a quadruple based on the inverse of the frequency with which either the subject entity or the object entity appear in the temporal knowledge graph 402. Indeed, in some implementations, the enhanced graph completion system 106 represents the likelihood, denoted by ϕ, of a quadruple (s, r, o, t) being selected for training as follows:

$$ϕ ( s , r , o , t ) = α 𝒫 ( s , r , o , t ) + ( 1 - α ) 𝒰 ( s , r , o , t ) \qquad ( 1 )$$

In equation 1, [symbol] (s, r, o, t) represents the probability of sampling the quadruple and is directly proportional to the inverse frequencies of the entities s and o. Additionally, [symbol] denotes a uniform probability function. Further, α represents a hyperparameter. Accordingly, in some embodiments, the enhanced graph completion system 106 modifies the value of α in response to user input received via computing device. As indicated, the enhanced graph completion system 106 uses α to assign weights to [symbol] (s, r, o, t) and [symbol] (s, r, o, t). In one or more embodiments, the enhanced graph completion system 106 more specifically defines [symbol] (s, r, o, t) to be proportional to either of the following:

$$mean ( \frac{1}{freq ( s )} , \frac{1}{freq ( o )} ) or max ( \frac{1}{freq ( s )} , \frac{1}{freq ( o )} ) \qquad ( 2 )$$

As shown by equation 2, in some embodiments, the enhanced graph completion system 106 defines the probability of sampling a quadruple as proportional to the inverse of the mean frequency with which entities s and o appear throughout the temporal knowledge graph 402. In some instances, the enhanced graph completion system 106 defines the probability as proportional to the inverse of the max frequencies with which those entities appear. In one or more embodiments, in the context of the continual learning framework, the enhanced graph completion system 106 determines the frequency of an entity is the number of times the entity appears up to the current training step. In other words, the enhanced graph completion system 106 does not compute the entity frequency using the entire dataset (e.g., does not account for appearances that occur after the current training step).

As further shown in FIG. 4, the enhanced graph completion system 106 uses a temporal knowledge graph completion model 408 to generate predicted relationships 410 from the training entities 406 extracted from the temporal knowledge graph 402. Indeed, in some embodiments, the enhanced graph completion system 106 uses the training entities 406 to generate a query and submits the query to the temporal knowledge graph completion model 408. The enhanced graph completion system 106 uses an enhancement layer 412 of the temporal knowledge graph completion model 408 to generate enhanced entity representations 414 from the training entities 406. For instance, in some embodiments, the enhanced graph completion system 106 uses the enhancement layer 412 to determine the enhanced entity representations 414 as follows:

$${e}_{s} = λ f ( s ) + \frac{1}{1 + exp ( {d}_{s} )} ( 1 - λ ) g ( s ) \qquad ( 3 )$$

In equation 3, f(s) denotes the embedding of entity s generated by the underlying completion component (e.g., the completion component 416). In one or more embodiments, the enhancement layer 412 includes a model-agnostic enhancement layer. Thus, the enhanced graph completion system 106 uses the enhancement layer 412 with various underlying completion components in various embodiments. Indeed, in some cases, the enhanced graph completion system 106 uses the enhancement layer 412 as part of a temporal knowledge graph completion model employed by conventional systems. To illustrate, in some cases, the enhanced graph completion system 106 uses the enhancement layer 412 with a graph neural network that has been trained to complete temporal knowledge graphs. Accordingly, in some cases, f(s) denotes the embedding for of entity s generated by an intermediate layer of a graph neural network. In one or more embodiments, f(s) represents a connection-based similarity between the entity s and one or more similar entities represented in the temporal knowledge graph 402. For instance, in some cases, f(s) is a representation of the entity s determined based on a local neighborhood proximity. In other words, f(s) represents a similarity determined between the entity s and one or more other entities based on their connectivity within the temporal knowledge graph 402.

Additionally, in equation 3, g(s) represents an enhancement function. In one or more embodiments, the enhancement function is temporal, and the enhanced graph completion system 106 uses the enhancement function to derive a representation for the entity s using a set of entities Sₜ(s) similar to s at time t. In one or more embodiments, the enhanced graph completion system 106 defines the two entities s₁ and s₂ as similar for the enhancement function if they have the same relationship type represented within the temporal knowledge graph 402. In other words, the enhanced graph completion system 106 defines the two entities s₁ and s₂ as similar if they are connected to any other entity (e.g., if their nodes are connected to the node of any other entity) within the temporal knowledge graph 402 via the same relationship type (e.g., the same type of connection or association). Thus, in some cases, the enhanced graph completion system 106 defines the set of entities that are similar to the entity s for the time t and relationship r as follows:

$${S}_{t} ( s , r ) = \{ {s}_{i} \vert ( {s}_{i} , r , {o}_{i} , {t}_{i} ) ∈ G , {t}_{i} < t \} \qquad ( 4 )$$

Thus, in one or more embodiments, g(s) represents a relationship-based similarity between the entity s and one or more similar entities represented in the temporal knowledge graph 402. In other words, g(s) represents a similarity between the entity s and one or more other entities based on the relationship types of those entities within the temporal knowledge graph 402. In one or more embodiments, the enhanced graph completion system 106 defines g(s) as follows:

$$g ( s , r ) = \frac{{\sum }_{{s}_{i} ∈ {S}_{t} ( s , r )} {w}_{i} {e}_{{s}_{i}}}{\sum {w}_{i}} , {w}_{i} = \frac{1}{1 + exp ( t - {t}_{i} )} \qquad ( 5 )$$

In equation 5, eₛ_{ᵢ} is the entity representation of another entity within the temporal knowledge graph 402. Further, wᵢ is a weighting applied to that entity representation. Thus, as indicated in equation 5, the enhanced graph completion system 106 uses the weighting to focus the enhancement function on entities associated with newer events (e.g., newer relationships resulting from those events) represented within the temporal knowledge graph 402. In other words, the enhanced graph completion system 106 applies a higher weighting to newer relationships within the temporal knowledge graph 402 and applies a lower weighting to older relationships within the temporal knowledge graph 402. Thus, in the context of continual learning, the enhanced graph completion system 106 focuses the enhancement function represented by equation 5 on those relationships that are represented by an update to the temporal knowledge graph 402 (e.g., relationships within the updated temporal knowledge graph that have not been represented in the temporal knowledge graph before the update).

Going back to equation 3, λ is a hyperparameter. Indeed, in some embodiments, the enhanced graph completion system 106 establishes or modifies the value of λ based on user input received from a computing device. Thus, as indicated by equation 3, the enhanced graph completion system 106 uses the hyperparameter λ to assign a weight to the connection-based similarity for the entity s represented by f(s) and to assign another weight to the relationship-based similarity for the entity s represented by the enhancement function g(s). Thus, as indicated by equation 3, the enhanced graph completion system 106 determines an enhanced entity representation for the entity s as a weighted combination of the connection-based similarity for the entity s and the relationship-based similarity for the entity s. Indeed, as shown in FIG. 4, the enhanced graph completion system 106 uses connection-based similarities 418 and relationship-based similarities 420 when determining the enhanced entity representations 414 using the enhancement layer 412.

Additionally, in equation 3, the term dₛ represents the number of connections the entity s has within the temporal knowledge graph 402. In particular, dₛ represents the number of direct connections between the entity s and other entities within the temporal knowledge graph 402. Thus, as shown in equation 3, the enhanced graph completion system 106 applies another weight to the relationship-based similarity for the entity s represented by the enhancement function g(s) based on the number of connections associated with s within the temporal knowledge graph 402. Indeed, the enhanced graph completion system 106 assigns a higher weight to the relationship-based similarity for entities having a lower number of connections within the temporal knowledge graph 402. Conversely, the enhanced graph completion system 106 assigns a lower weight to the relationship-based similarity for entities having a higher number of connections within the temporal knowledge graph 402. Thus, in some embodiments, the enhanced graph completion system 106 uses the enhanced entity representation of equation 3 to generate enhanced entity representations that account for both connection-based similarity and relationship-based similarity. For those entities with lower connectivity within the temporal knowledge graph 402, the enhanced entity representation ensures that other useful similarities are still accounted for.

As shown in FIG. 4, the enhanced graph completion system 106 uses the completion component 416 of the temporal knowledge graph completion model 408 to generate the predicted relationships 410 from the enhanced entity representations 414. In some cases, the enhanced graph completion system 106 generates the predicted relationships 410 by generating a prediction of the relationship between training entities at a time indicated by the query. In some instances, the enhanced graph completion system 106 generates the predicted relationships 410 by generating predicted object entities having a relationship with the training entities at a time indicated by the query. As further shown in FIG. 4, the enhanced graph completion system 106 uses a loss function 422 to compare the predicted relationships 410 to ground truth relationships 424 (determined from the temporal knowledge graph 402) and back propagates any determined loss back to the temporal knowledge graph completion model 408 (as shown by the dashed line 426). The enhanced graph completion system 106 uses the back propagation to modify the parameters of the temporal knowledge graph completion model 408.

FIG. 4 shows one training iteration; as mentioned above, however, the enhanced graph completion system 106 uses multiple training iterations to determine the parameters for the temporal knowledge graph completion model 408. Where the parameters have already been determined in a previous training task (e.g., determined for a previous iteration of the temporal knowledge graph completion model 408), the enhanced graph completion system 106 uses the training iterations to update the parameters (e.g., determine parameters for a subsequent iteration of the temporal knowledge graph completion model 408). Thus, in some embodiments, the enhanced graph completion system 106 updates the parameters of the temporal knowledge graph completion model 408 to accommodate the temporal knowledge graph 402 as new events become represented therein.

Thus, the enhanced graph completion system 106 trains a temporal knowledge graph completion model to generate predicted relationships for entities within a temporal knowledge graph. In particular, in some embodiments, the enhanced graph completion system 106 trains the temporal knowledge graph completion model using the temporal knowledge graph and also uses the trained temporal knowledge graph completion model to generated predicted queries for the temporal knowledge graph. In one or more embodiments, the enhanced graph completion system 106 uses the trained temporal knowledge graph completion model to perform a natural language processing task. For instance, in some cases, the enhanced graph completion system 106 uses the trained temporal knowledge graph completion model in combination with a large language model, such as to answer questions or retrieve information. To illustrate, in some cases, the enhanced graph completion system 106 uses a large language model to generate a query based on user input received from a computing device. The enhanced graph completion system 106 further provides the query to the temporal knowledge graph completion model for generating a predicted relationship based on the query. The enhanced graph completion system 106 uses the large language model to provide the predicted relationship as a response to the user input.

By using enhanced entity representations as described above, the enhanced graph completion system 106 operates with improved flexibility when compared to conventional systems. Indeed, while many conventional systems rigidly rely on connection-based similarities for entity representations, the enhanced graph completion system 106 incorporates other useful similarities within its enhanced entity representations. Further, the enhanced graph completion system 106 uses weighted frequency-based sampling to boost the visibility of entities with low connectivity within the training data, enabling the completion model to adequately learn how to account for these entities at inference time.

By determining model parameters using the enhanced entity representations and weighted frequency-based sampling, the enhanced graph completion system 106 produces and implements a model that generates more accurate predicted relationships. Indeed, the enhanced graph completion system 106 determines model parameters that more accurately predict object entities or relationships for a subject entity at a given time indicated by a query. Further, by using the methods described above in combination with incremental training in the continual learning framework, the enhanced graph completion system 106 facilitates updating the model parameters to accommodate new events while avoiding the complete retraining of the model that is implemented by some conventional systems. Thus, the enhanced graph completion system 106 reduces the computing resources that are consumed by many conventional systems to keep the model parameters up to date.

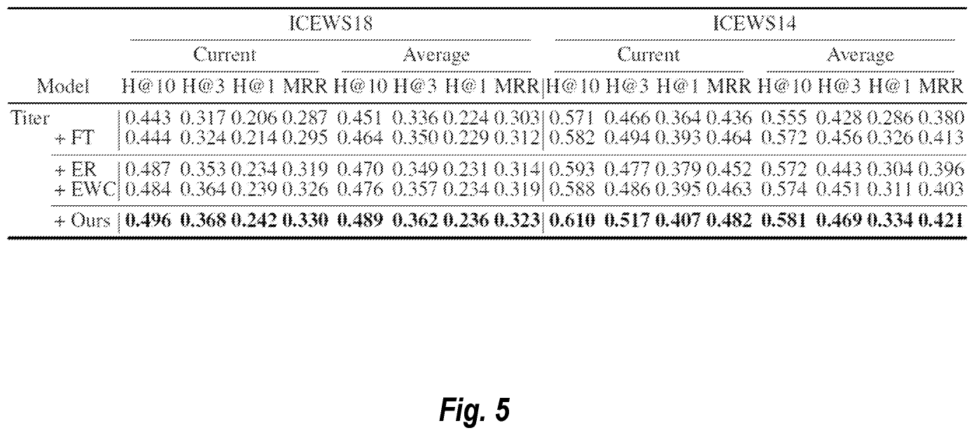

As previously mentioned, the enhanced graph completion system 106 operates with improved accuracy when compared to conventional systems. In particular, the enhanced graph completion system 106 generates more accurate relationship predictions. Researchers have conducted studies to determine the accuracy of the enhanced graph completion system 106 compared to many existing systems. FIGS. 5-8 illustrate tables and graphs reflecting experimental results regarding the effectiveness of the enhanced graph completion system 106 in accordance with one or more embodiments.

FIG. 5 illustrates a table comparing the total link prediction performance of an embodiment of the enhanced graph completion system 106 with several existing approaches. Each tested model incorporates, as the base model (e.g., the completion component), the Time Traveler (TITer)—a state-of-the-art inductive model—described by Haohai Sun et al., Timetraveler: Reinforcement Learning for Temporal Knowledge Graph Forecasting, arXiv preprint arXiv: 2109.04101, 2021. The table compares the performance of the enhanced graph completion system 106 using the TITer model as the base model with several other varied implementations of the TITer model. For instance, the table provides the performance of a base implementation of the TITer model as well as an implementation in which naive fine-tuning (FT) of the model parameters is used. The table further provides the performance of an implementation that incorporates a regularization-based method of continual learning known as Elastic Weight Consolidation (EWC) described by James Kirkpatrick et al., Overcoming Catastrophic Forgetting in Neural Networks, Proceedings of the National Academy of Sciences, 114 (13): 3521-3526, 2017. The table also provides the performance of an implementation that incorporates an Experience Relay (ER) method of continual learning described by David Rolnick et al., Experience Replay for Continual Learning, Advances in Neural Information Processing Systems, 32, 2019. The enhanced graph completion system 106 and the FT, EWC, and ER implementations were trained through an incremental training framework.

As shown, the table compares the performance of each tested model on multiple configurations of the Integrated Crisis Early Warning System (ICEWS) datasets, which record interactions among geopolitical actors with daily event timestamps, described by E Boschee et al., Integrated Crisis Early Warning System (ICEWS) Coded Event Data, 2015. As further shown, the table compares the performances using the Mean Reciprocated Rank (MRR) metric and various Hit@k metrics. The table shows the average model performance over all test data from the previous graph snapshots as well as the current test data.

As shown in FIG. 5, the basic TITer implementation demonstrates limited performance for both the latest snapshot and the average from previous snapshots, highlighting the model's difficulty in effectively transferring knowledge. In other words, the model suffers from the forgetting problem, which degrades its performance on previously learned tasks. While each of the other tested models provide some improvement over the basic TITer implementation, the enhanced graph completion system 106 provides the most improvement across all metrics shown, with the most significant gains in MMR and Hit@10. This underscores the effectiveness of the enhanced graph completion system 106 in improving link prediction and mitigating the effects of catastrophic forgetting, particularly within an incremental training framework.

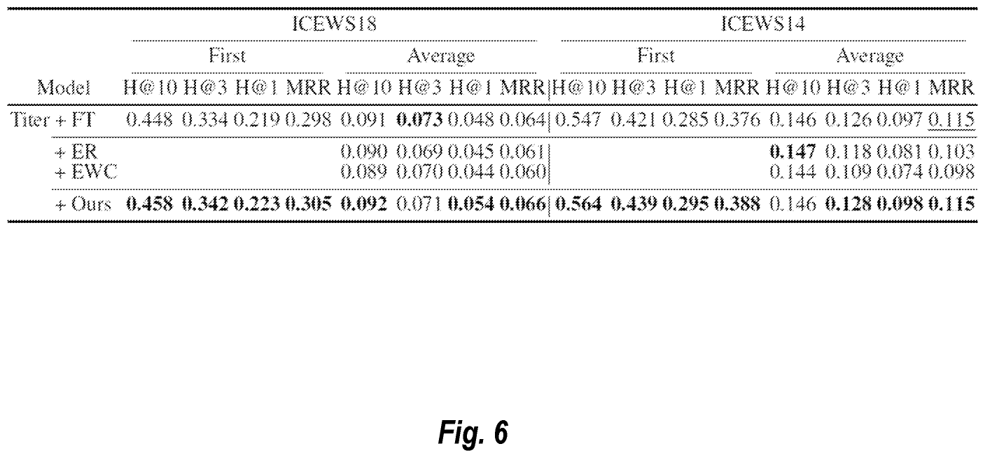

FIG. 6 illustrates another table comparing the inductive link prediction performance of the enhanced graph completion system 106 with the other tested models. In particular, the table of FIG. 6, provides the performance of each tested model in predicting relationships involving entities that were not seen during the training process. In the incremental training framework, an entity s at training step t is considered unseen if it hasn't appeared in the temporal knowledge graph in previous training steps and also the current training data, i.e., s∉Uⱼ₌₁^{t-1} [symbol] ⱼ∪Dₜ^{train}.

For the tested models, the table of FIG. 6 shows the performance results (labeled “First”) for the first inductive test in which the first iteration of the model was used, trained on the initial snapshot of the temporal knowledge graph. Notably, the results for the FT, EWC, and ER models are identical during this initial training as they use the same data and model architecture; thus, the results for EWC and ER are omitted. The table also shows the performance of the final model trained on all test sets.

As shown, the enhanced graph completion system 106 outperforms all models for the first snapshot. The enhanced graph completion system 106 also shows substantial improvement over the final iteration of each model. Thus, FIG. 6 shows that the enhanced graph completion system 106 provides advantages when predicting relationships for entities unsee during training.

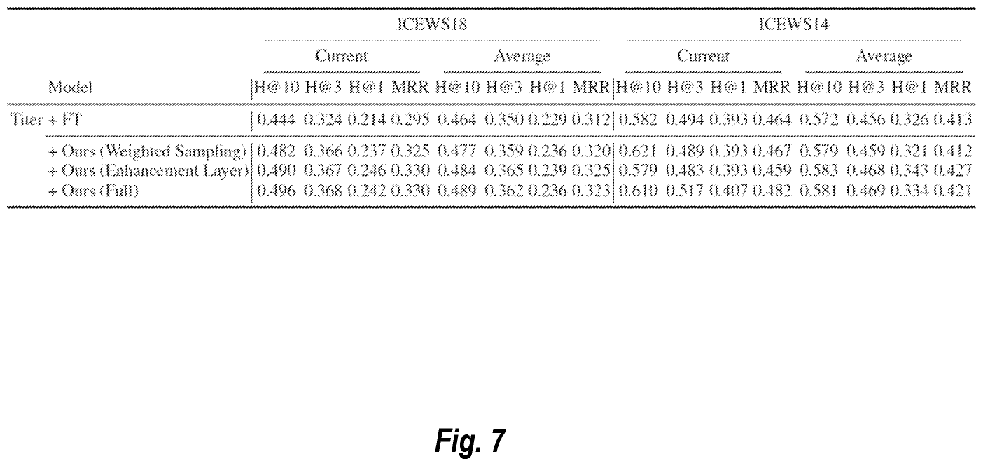

FIG. 7 illustrates a table comparing the performance of various embodiments of the enhanced graph completion system 106 with the basic FT model. In particular, the table of FIG. 7 provides the results of an ablation study in which contributions of the enhancement layer and the weighted frequency-based sampling of the enhanced graph completion system 106 were measured. As shown by FIG. 7, each component of the enhanced graph completion system 106 contributes to an overall performance improvement. Specifically, the enhancement layer and the weighted frequency-based sampling individually boost the model's performance with the full combination providing the best performance in many respects.

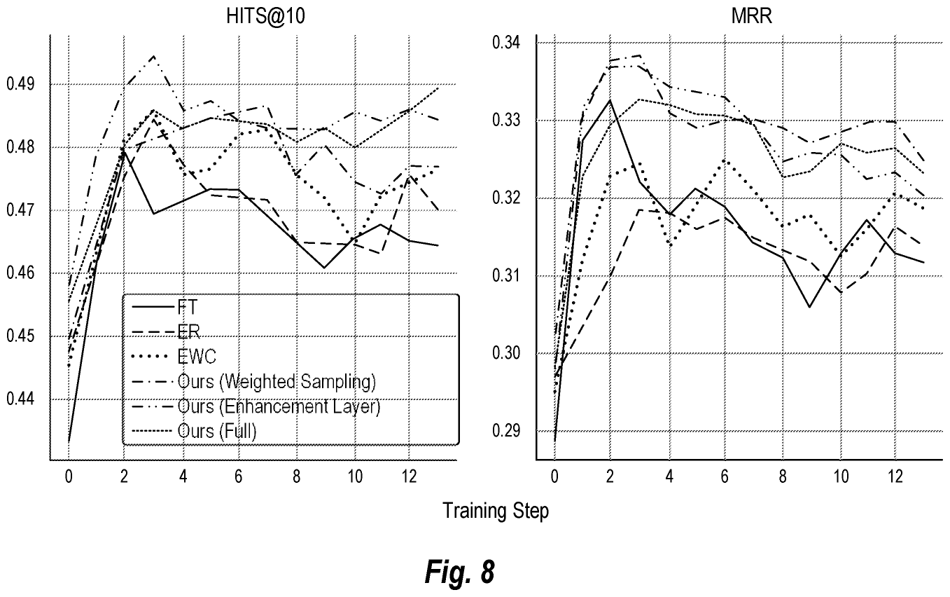

FIG. 8 illustrates graphs that provide further analysis of the contributions of each component of the enhanced graph completion system 106 in incremental learning. In particular, the graphs of FIG. 8 illustrate how the components mitigate the problem of catastrophic forgetting that plagues many existing systems. Specifically, at time t, the average performance of the model [symbol] ₜ over the current test set and all previous ones is computed. The performance at time t is defined as

$${P}_{t} = \frac{1}{t} {\sum }_{j = 1}^{t} {p}_{t , j}$$

where p_{t,j} represents the performance of [symbol] ₜ on Dⱼ^{test}. As shown by the graphs of FIG. 8, the components of the enhanced graph completion system 106, both individually and in combination provide improved performance over the other models with respect to catastrophic forgetting. This is evidenced at least in part by the reduced performance decline over time. Notably, the enhancement layer provides the most significant improvements.

Turning now to FIG. 9, additional detail will now be provided regarding various components and capabilities of the enhanced graph completion system 106. In particular, FIG. 9 illustrates the enhanced graph completion system 106 implemented by the computing device 900 (e.g., the server(s) 102 and/or one of the client devices 110a-110n discussed above with reference to FIG. 1). Additionally, the enhanced graph completion system 106 is also part of the analytics system 104. As shown, in one or more embodiments, the enhanced graph completion system 106 includes, but is not limited to, a completion model training engine 902, a completion model application manager 904, and data storage 906 (which includes a temporal knowledge graph 908 and a temporal knowledge graph completion model 910).

As just mentioned, and as illustrated in FIG. 9, the enhanced graph completion system 106 includes the completion model training engine 902. In one or more embodiments, the completion model training engine 902 trains a temporal knowledge graph completion model to generate predicted relationships for entities within a temporal knowledge graph in response to queries. In some embodiments, the completion model training engine 902 trains the temporal knowledge graph completion model using an incremental training framework to facilitate continual learning. In some instances, the completion model training engine 902 uses a weighted frequency-based sampling strategy to select entities for use during training.

Additionally, as shown in FIG. 9, the enhanced graph completion system 106 includes the completion model application manager 904. In one or more embodiments, the completion model application manager 904 implements a trained temporal knowledge graph completion model. For instance, in some cases, the completion model application manager 904 receives a query and uses the trained temporal knowledge graph completion model to generate a predicted relationship in response to the query.

As shown in FIG. 9, the enhanced graph completion system 106 further includes data storage 906. In particular, data storage 906 includes the temporal knowledge graph 908 and the temporal knowledge graph completion model 910.

Each of the components 902-910 of the enhanced graph completion system 106 optionally include software, hardware, or both. For example, the components 902-910 include one or more instructions stored on a computer-readable storage medium and executable by processors of one or more computing devices, such as a client device or server device. When executed by the one or more processors, the computer-executable instructions of the enhanced graph completion system 106 cause the computing device(s) to perform the methods described herein. Alternatively, the components 902-910 include hardware, such as a special-purpose processing device to perform a certain function or group of functions. Alternatively, the components 902-910 of the enhanced graph completion system 106 include a combination of computer-executable instructions and hardware.

Furthermore, the components 902-910 of the enhanced graph completion system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 902-910 of the enhanced graph completion system 106 may be implemented as a stand-alone application, such as a desktop or mobile application. Furthermore, the components 902-910 of the enhanced graph completion system 106 may be implemented as one or more web-based applications hosted on a remote server. Alternatively, or additionally, the components 902-910 of the enhanced graph completion system 106 may be implemented in a suite of mobile device applications or “apps.” For example, in one or more embodiments, the enhanced graph completion system 106 comprises or operates in connection with digital software applications such as ADOBE® DOCUMENT CLOUD® or ADOBE® EXPERIENCE CLOUD®. The foregoing are either registered trademarks or trademarks of Adobe Inc. in the United States and/or other countries.

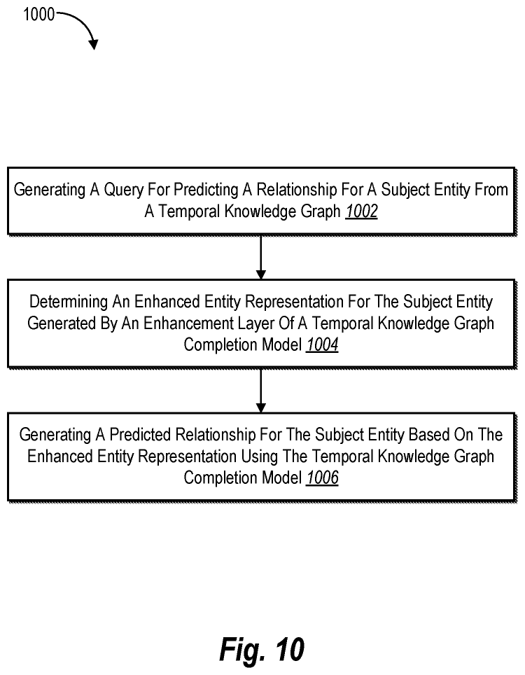

FIGS. 1-9, the corresponding text, and the examples provide a number of different methods, systems, devices, and non-transitory computer-readable media of the enhanced graph completion system 106. In addition to the foregoing, one or more embodiments can also be described in terms of flowcharts comprising acts for accomplishing the particular result, as shown in FIG. 10. FIG. 10 may be performed with more or fewer acts. Further, the acts may be performed in different orders. Additionally, the acts described herein may be repeated or performed in parallel with one another or in parallel with different instances of the same or similar acts.

FIG. 10 illustrates a flowchart of a series of acts 1000 for generating a predicted relationship for an entity represented in a temporal knowledge graph in accordance with one or more embodiments. FIG. 10 illustrates acts according to one embodiment, alternative embodiments may omit, add to, reorder, and/or modify any of the acts shown in FIG. 10. In some implementations, the acts of FIG. 10 are performed as part of a computer-implemented method. Alternatively, a non-transitory computer-readable medium can store executable instructions thereon that, when executed by a processing device, cause the processing device to perform operations comprising the acts of FIG. 10. In some embodiments, a system performs the acts of FIG. 10. For example, in one or more embodiments, a system includes one or more memory devices. The system further includes one or more processors configured to cause the system to perform the acts of FIG. 10.

The series of acts 1000 includes an act 1002 for generating a query for predicting a relationship for a subject entity from a temporal knowledge graph. For example, in one or more embodiments, the act 1002 involves generating a query for predicting a relationship for a subject entity represented within a temporal knowledge graph.

The series of acts 1000 also includes an act 1004 for determining an enhanced entity representation for the subject entity generated by an enhancement layer of a temporal knowledge graph completion model. For instance, in some embodiments, the act 1004 involves determining an enhanced entity representation generated for the subject entity by an enhancement layer of a temporal knowledge graph completion model, the enhanced entity representation including a combination of a connection-based similarity for the subject entity and a relationship-based similarity for the subject entity.

In one or more embodiments, determining the enhanced entity representation comprises: determining a weighted combination of the connection-based similarity of the subject entity and the relationship-based similarity; and determining a weighting for the weighted combination based on a number of connections associated with the subject entity within the temporal knowledge graph.

The series of acts 1000 further includes an act 1006 for generating a predicted relationship for the subject entity based on the enhanced entity representation using the temporal knowledge graph completion model. To illustrate, in some cases, the act 1006 involves generating, using the temporal knowledge graph completion model and based on the enhanced entity representation of the subject entity, a predicted relationship for the subject entity.

In one or more embodiments, generating the predicted relationship using the temporal knowledge graph completion model comprises generating the predicted relationship using a graph neural network. In some cases, generating the query comprises generating the query to indicate the subject entity, the relationship, and a timestamp for predicting the relationship. Accordingly, in some instances, generating, using the temporal knowledge graph completion model, the predicted relationship for the subject entity by generating a predicted object entity having the relationship with the subject entity at the timestamp. Further, in some embodiments, generating the query comprises generating the query to indicate the subject entity, an object entity, and a timestamp for predicting the relationship. As such, in some instances, generating, using the temporal knowledge graph completion model, the predicted relationship for the subject entity by generating a prediction of the relationship between the subject entity and the object entity at the timestamp.

In one or more embodiments, generating the predicted relationship for the subject entity using the temporal knowledge graph completion model comprises generating a prediction that the subject entity will have the predicted relationship at a timestamp that follows a latest timestamp represented within the temporal knowledge graph.

In one or more embodiments, the enhanced graph completion system 106 further determines an update to the temporal knowledge graph that includes at least one of a new entity or a new relationship between entities represented within the temporal knowledge graph; and modifies parameters of the temporal knowledge graph completion model based on an updated enhanced entity representation for at least one entity from the entities represented within the temporal knowledge graph in accordance with the update to the temporal knowledge graph. In some embodiments, the enhanced graph completion system 106 generates, using the enhancement layer of the temporal knowledge graph completion model, the updated enhanced entity representation for the at least one entity in accordance with the update to the temporal knowledge graph based on a relationship-based similarity for the at least one entity that provides a higher weighting to new relationships represented by the update to the temporal knowledge graph compared to other relationships previously represented in the temporal knowledge graph.

In one or more embodiments, the series of acts 1000 further includes acts for training a temporal knowledge graph completion model. To provide an illustration, in some embodiments, the acts involve determining parameters for a temporal knowledge graph completion model using a first iteration of a temporal knowledge graph that includes a set of entities; receiving a second iteration of the temporal knowledge graph that follows the first iteration in time and includes the set of entities; determining a subset of entities from the set of entities by using a weighted frequency-based sampling that selects entities based on a probability that is inversely proportional to a frequency of appearance of the entities within the second iteration of the temporal knowledge graph; generating, using an enhancement layer of the temporal knowledge graph completion model, enhanced entity representations for a subset of entities using combinations of connection-based similarities and relationship-based similarities for the subset of entities; generating, via the temporal knowledge graph completion model, predicted relationships for the subset of entities based on the enhanced entity representations; and modifying the parameters of the temporal knowledge graph completion model based on comparing the predicted relationships to ground truth relationships from the second iteration of the temporal knowledge graph.

In some embodiments, generating the enhanced entity representations for the subset of entities using the enhancement layer comprises assigning weights to the relationship-based similarities based on a recency of relationships associated with the relationship-based similarities. In some instances, generating the enhanced entity representations for the subset of entities using the combinations of the connection-based similarities and the relationship-based similarities for the subset of entities comprises weighing the relationship-based similarities higher for one or more entities from the subset of entities that have fewer connections within the temporal knowledge graph compared to other entities from the subset of entities that have more connections within the temporal knowledge graph.

In some instances, the enhanced graph completion system 106 determines a relationship-based similarity between an entity from the subset of entities and an additional entity based on determining that the entity and the additional entity have a relationship of a same relationship type represented within the temporal knowledge graph. Further, in certain embodiments, the enhanced graph completion system 106 generates, using the temporal knowledge graph completion model before modifying the parameters, a predicted relationship between a subject entity and an object entity from the set of entities of the first iteration of the temporal knowledge graph.

To provide another illustration, in one or more embodiments, the acts involve generating, using an enhancement layer of a temporal knowledge graph completion model, enhanced entity representations for a plurality of entities represented within a temporal knowledge graph using combinations of connection-based similarities for the plurality of entities and relationship-based similarities for the plurality of entities; generating, via the temporal knowledge graph completion model, predicted relationships within the temporal knowledge graph based on the enhanced entity representations, each predicted relationship comprising a subject entity and an object entity from the plurality of entities; and determining parameters for the temporal knowledge graph completion model based on comparing the predicted relationships to ground truth relationships from the temporal knowledge graph.

In certain embodiments, generating the enhanced entity representations for the plurality of entities using the enhancement layer of the temporal knowledge graph completion model comprises generating the enhanced entity representations using a model-agnostic enhancement layer coupled to the temporal knowledge graph completion model. In some embodiments, generating the enhanced entity representations using the combinations of the connection-based similarities and the relationship-based similarities comprises assigning a first weight to the connection-based similarities and a second weight to the relationship-based similarities based on a hyperparameter established via user input received from a client device. Further, in some cases, generating the enhanced entity representations using the combinations of the connection-based similarities and the relationship-based similarities comprises generating an enhanced entity representation for an entity from the plurality of entities by assigning a third weight to one or more relationship-based similarities determined for the entity based on a number of connections associated with the entity within the temporal knowledge graph.

In some implementations, determining the parameters for the temporal knowledge graph completion model based on comparing the predicted relationships to ground truth relationships from the temporal knowledge graph comprises determining the parameters based on comparing the predicted relationships generated from a first iteration of the temporal knowledge graph to the ground truth relationships from the first iteration of the temporal knowledge graph; and the enhanced graph completion system 106 further updates the parameters for the temporal knowledge graph completion model based on comparing additional predicted relationships generated from a second iteration of the temporal knowledge graph to additional ground truth relationships from the second iteration of the temporal knowledge graph, the second iteration comprising new entities and new relationships that are not represented within the first iteration. In some cases, the enhanced graph completion system 106 determines the additional predicted relationships from the second iteration of the temporal knowledge graph by: generating, using the enhancement layer of the temporal knowledge graph completion model, one or more enhanced entity representations for one or more new entities represented within the second iteration of the temporal knowledge graph; and generates, using the temporal knowledge graph completion model, one or more predicted relationships based on the one or more enhanced entity representations.

Further, in some cases, the enhanced graph completion system 106 performs a natural language processing task using the temporal knowledge graph completion model in combination with a large language model.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 illustrates a block diagram of an example computing device 1100 that may be configured to perform one or more of the processes described above. One will appreciate that one or more computing devices, such as the computing device 1100 may represent the computing devices described above (e.g., the server(s) 102 and/or the client devices 110a-110n). In one or more embodiments, the computing device 1100 may be a mobile device (e.g., a mobile telephone, a smartphone, a PDA, a tablet, a laptop, a camera, a tracker, a watch, a wearable device). In some embodiments, the computing device 1100 may be a non-mobile device (e.g., a desktop computer or another type of client device). Further, the computing device 1100 may be a server device that includes cloud-based processing and storage capabilities.

As shown in FIG. 11, the computing device 1100 can include one or more processor(s) 1102, memory 1104, a storage device 1106, input/output interfaces 1108 (or “I/O interfaces 1108”), and a communication interface 1110, which may be communicatively coupled by way of a communication infrastructure (e.g., bus 1112). While the computing device 1100 is shown in FIG. 11, the components illustrated in FIG. 11 are not intended to be limiting. Additional or alternative components may be used in other embodiments. Furthermore, in certain embodiments, the computing device 1100 includes fewer components than those shown in FIG. 11. Components of the computing device 1100 shown in FIG. 11 will now be described in additional detail.

In particular embodiments, the processor(s) 1102 includes hardware for executing instructions, such as those making up a computer program. As an example, and not by way of limitation, to execute instructions, the processor(s) 1102 may retrieve (or fetch) the instructions from an internal register, an internal cache, memory 1104, or a storage device 1106 and decode and execute them.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1104 may be internal or distributed memory.

The computing device 1100 includes a storage device 1106 including storage for storing data or instructions. As an example, and not by way of limitation, the storage device 1106 can include a non-transitory storage medium described above. The storage device 1106 may include a hard disk drive (HDD), flash memory, a Universal Serial Bus (USB) drive or a combination these or other storage devices.

As shown, the computing device 1100 includes one or more I/O interfaces 1108, which are provided to allow a user to provide input to (such as user strokes), receive output from, and otherwise transfer data to and from the computing device 1100. These I/O interfaces 1108 may include a mouse, keypad or a keyboard, a touch screen, camera, optical scanner, network interface, modem, other known I/O devices or a combination of such I/O interfaces 1108. The touch screen may be activated with a stylus or a finger.

The I/O interfaces 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1108 are configured to provide graphical data to a display for presentation to a user. The graphical data may be representative of one or more graphical user interfaces and/or any other graphical content as may serve a particular implementation.

The computing device 1100 can further include a communication interface 1110. The communication interface 1110 can include hardware, software, or both. The communication interface 1110 provides one or more interfaces for communication (such as, for example, packet-based communication) between the computing device and one or more other computing devices or one or more networks. As an example, and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can include hardware, software, or both that connects components of computing device 1100 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
generating a query for predicting a relationship for a subject entity represented within a temporal knowledge graph;
determining an enhanced entity representation generated for the subject entity by an enhancement layer of a temporal knowledge graph completion model, the enhanced entity representation including a combination of a connection-based similarity for the subject entity and a relationship-based similarity for the subject entity; and
generating, using the temporal knowledge graph completion model and based on the enhanced entity representation of the subject entity, a predicted relationship for the subject entity.

2. The computer-implemented method of claim 1, wherein determining the enhanced entity representation comprises:
determining a weighted combination of the connection-based similarity of the subject entity and the relationship-based similarity; and
determining a weighting for the weighted combination based on a number of connections associated with the subject entity within the temporal knowledge graph.

3. The computer-implemented method of claim 1, further comprising:
determining an update to the temporal knowledge graph that includes at least one of a new entity or a new relationship between entities represented within the temporal knowledge graph; and
modifying parameters of the temporal knowledge graph completion model based on an updated enhanced entity representation for at least one entity from the entities represented within the temporal knowledge graph in accordance with the update to the temporal knowledge graph.

4. The computer-implemented method of claim 3, further comprising generating, using the enhancement layer of the temporal knowledge graph completion model, the updated enhanced entity representation for the at least one entity in accordance with the update to the temporal knowledge graph based on a relationship-based similarity for the at least one entity that provides a higher weighting to new relationships represented by the update to the temporal knowledge graph compared to other relationships previously represented in the temporal knowledge graph.

5. The computer-implemented method of claim 1, wherein generating the predicted relationship using the temporal knowledge graph completion model comprises generating the predicted relationship using a graph neural network.

6. The computer-implemented method of claim 1, wherein:
generating the query comprises generating the query to indicate the subject entity, the relationship, and a timestamp for predicting the relationship; and
generating, using the temporal knowledge graph completion model, the predicted relationship for the subject entity by generating a predicted object entity having the relationship with the subject entity at the timestamp.

7. The computer-implemented method of claim 1, wherein:
generating the query comprises generating the query to indicate the subject entity, an object entity, and a timestamp for predicting the relationship; and
generating, using the temporal knowledge graph completion model, the predicted relationship for the subject entity by generating a prediction of the relationship between the subject entity and the object entity at the timestamp.

8. The computer-implemented method of claim 1, wherein generating the predicted relationship for the subject entity using the temporal knowledge graph completion model comprises generating a prediction that the subject entity will have the predicted relationship at a timestamp that follows a latest timestamp represented within the temporal knowledge graph.

9. A system comprising:
one or more memory devices; and
one or more processors configured to cause the system to:
determine parameters for a temporal knowledge graph completion model using a first iteration of a temporal knowledge graph that includes a set of entities;
receive a second iteration of the temporal knowledge graph that follows the first iteration in time and includes the set of entities;
determine a subset of entities from the set of entities by using a weighted frequency-based sampling that selects entities based on a probability that is inversely proportional to a frequency of appearance of the entities within the second iteration of the temporal knowledge graph;
generate, using an enhancement layer of the temporal knowledge graph completion model, enhanced entity representations for a subset of entities using combinations of connection-based similarities and relationship-based similarities for the subset of entities;
generate, via the temporal knowledge graph completion model, predicted relationships for the subset of entities based on the enhanced entity representations; and
modify the parameters of the temporal knowledge graph completion model based on comparing the predicted relationships to ground truth relationships from the second iteration of the temporal knowledge graph.

10. The system of claim 9, wherein the one or more processors are configured to cause the system to generate the enhanced entity representations for the subset of entities using the enhancement layer by assigning weights to the relationship-based similarities based on a recency of relationships associated with the relationship-based similarities.

11. The system of claim 9, wherein the one or more processors are configured to cause the system to generate the enhanced entity representations for the subset of entities using the combinations of the connection-based similarities and the relationship-based similarities for the subset of entities by weighing the relationship-based similarities higher for one or more entities from the subset of entities that have fewer connections within the temporal knowledge graph compared to other entities from the subset of entities that have more connections within the temporal knowledge graph.

12. The system of claim 9, wherein the one or more processors are further configured to cause the system to determine a relationship-based similarity between an entity from the subset of entities and an additional entity based on determining that the entity and the additional entity have a relationship of a same relationship type represented within the temporal knowledge graph.

13. The system of claim 9, wherein the one or more processors are further configured to cause the system to generate, using the temporal knowledge graph completion model before modifying the parameters, a predicted relationship between a subject entity and an object entity from the set of entities of the first iteration of the temporal knowledge graph.

14. A non-transitory computer-readable medium storing executable instructions which, when executed by a processing device, cause the processing device to perform operations comprising:
generating, using an enhancement layer of a temporal knowledge graph completion model, enhanced entity representations for a plurality of entities represented within a temporal knowledge graph using combinations of connection-based similarities for the plurality of entities and relationship-based similarities for the plurality of entities;
generating, via the temporal knowledge graph completion model, predicted relationships within the temporal knowledge graph based on the enhanced entity representations, each predicted relationship comprising a subject entity and an object entity from the plurality of entities; and
determining parameters for the temporal knowledge graph completion model based on comparing the predicted relationships to ground truth relationships from the temporal knowledge graph.

15. The non-transitory computer-readable medium of claim 14, wherein generating the enhanced entity representations for the plurality of entities using the enhancement layer of the temporal knowledge graph completion model comprises generating the enhanced entity representations using a model-agnostic enhancement layer coupled to the temporal knowledge graph completion model.

16. The non-transitory computer-readable medium of claim 14, wherein generating the enhanced entity representations using the combinations of the connection-based similarities and the relationship-based similarities comprises assigning a first weight to the connection-based similarities and a second weight to the relationship-based similarities based on a hyperparameter established via user input received from a client device.

17. The non-transitory computer-readable medium of claim 16, wherein generating the enhanced entity representations using the combinations of the connection-based similarities and the relationship-based similarities comprises generating an enhanced entity representation for an entity from the plurality of entities by assigning a third weight to one or more relationship-based similarities determined for the entity based on a number of connections associated with the entity within the temporal knowledge graph.

18. The non-transitory computer-readable medium of claim 14, wherein:
determining the parameters for the temporal knowledge graph completion model based on comparing the predicted relationships to ground truth relationships from the temporal knowledge graph comprises determining the parameters based on comparing the predicted relationships generated from a first iteration of the temporal knowledge graph to the ground truth relationships from the first iteration of the temporal knowledge graph; and
the operations further comprise updating the parameters for the temporal knowledge graph completion model based on comparing additional predicted relationships generated from a second iteration of the temporal knowledge graph to additional ground truth relationships from the second iteration of the temporal knowledge graph, the second iteration comprising new entities and new relationships that are not represented within the first iteration.

19. The non-transitory computer-readable medium of claim 18, wherein the operations further comprise determining the additional predicted relationships from the second iteration of the temporal knowledge graph by:
generating, using the enhancement layer of the temporal knowledge graph completion model, one or more enhanced entity representations for one or more new entities represented within the second iteration of the temporal knowledge graph; and
generating, using the temporal knowledge graph completion model, one or more predicted relationships based on the one or more enhanced entity representations.

20. The non-transitory computer-readable medium of claim 14, wherein the operations further comprise performing a natural language processing task using the temporal knowledge graph completion model in combination with a large language model.
